(19) United States
(12) Patent Application Publication
(10) Pub. No.: US 2023/0348117 A1
(43) Pub. Date: Nov. 2, 2023

(54) METHOD FOR RE-ENTRY PREDICTION OF UNCONTROLLED ARTIFICIAL SPACE OBJECT

(71) Applicant: KOREA ASTRONOMY AND SPACE SCIENCE INSTITUTE, Daejeon (KR)

(72) Inventor: Eun Jung CHOI, Daejeon (KR)

(73) Assignee: KOREA ASTRONOMY AND SPACE SCIENCE INSTITUTE, Daejeon (KR)

(21) Appl. No.: 18/350,740

(22) Filed: Jul. 11, 2023

Related U.S. Application Data
(63) Continuation-in-part of application No. 16/146,157, filed on Sep. 28, 2018, now abandoned.

(30) Foreign Application Priority Data
Jun. 10, 2018 (KR) 10-2018-0063148

(51) Int. Cl. B64G 3/00; G06F 17/17

(52) U.S. Cl. CPC B64G 3/00; G06F 17/175

(57) ABSTRACT

A method for re-entry prediction of an uncontrolled artificial space object includes: calculating an average semi-major axis and an argument of latitude by inputting two-line elements or osculating elements of an artificial space object at two different time points; calculating an average semi-major axis, argument of latitude, and atmospheric drag at a second time point; estimating an optimum drag scale factor while changing the drag scale factor; predicting the time and place of re-entry of an artificial space object into the atmosphere by applying the estimated drag scale factor. Here, orbit prediction is performed by using a Cowell's high-precision orbital propagator using numerical integration from the second time point to a re-entry time point.

### CROSS REFERENCE TO RELATED APPLICATIONS

This application is a continuation-in-part application of co-pending U.S. application Ser. No. 16/146,157, filed Sep. 28, 2018, the disclosure of which is incorporated herein by reference. The present application claims priority to Korean Patent Application No. 10-2018-0063148, filed Jun. 10, 2018, the entire contents of which is incorporated herein for all purposes by this reference.

### BACKGROUND

### Technical Field

The disclosure relates to a method for re-entry prediction of an artificial space object and, more particularly, to a method for re-entry prediction of an uncontrolled artificial space object by using a drag scale factor estimation (DSFE) method.

### Background Art

The re-entry of an uncontrolled artificial space object of 1 ton or more is highly likely to cause damage to the ground. Therefore, the domestic response manual for a crash and collision of an artificial space object specifies that a crisis alert for the re-entry status of the space object is issued when an artificial space object reaches an altitude of 250 km or less. Accordingly, it is very important to provide accurate re-entry prediction information quickly in order to predict the re-entry status and risk of damage by artificial space objects.

Particularly, when artificial space objects fall and reach an altitude of 250 km, the artificial space objects begin the re-entry process into the atmosphere within about one month, and at the re-entry of an artificial space object with a weight of 1 ton or more, fragments of about 10 to 40% of the artificial space object reach the earth's surface. Particularly, the re-entry of an uncontrolled artificial space object is difficult to predict, which results in loss of lives and assets on the ground. Therefore, to prepare for the re-entry risk of space objects, a technique of predicting the re-entry risk of space objects is necessary to minimize such risk.

A method for re-entry prediction of an uncontrolled artificial space object in the related art is configured to predict a re-entry time point by using the simplified general perturbations 4 (SGP4) orbit propagator using two-line elements (TLE). However, when comparing the predicted re-entry time point with actual re-entry estimation time point and place, the prediction accuracy is very low, whereby there is a problem of not being applied to the re-entry status of the actual space object.

### SUMMARY

In order to solve the above problems, the disclosure provides a method for re-entry prediction of an uncontrolled artificial space object which is configured to accurately predict an expected time point and place of a re-entry of the space object by using a drag scale factor estimation (DSFE) method.

In order to achieve the above object, an embodiment of the disclosure provides a method for re-entry prediction of an uncontrolled artificial space object, the method includes: calculating an average semi-major axis and an argument of latitude by inputting two-line elements (TLE) or osculating elements of the artificial space object at two different time points; calculating an average semi-major axis, an argument of latitude, and an atmospheric drag at a second time point of the two different time points by performing orbital propagation with a Cowell's high-precision orbital propagator using numerical integration up to the second time point, the orbital propagation being performed by applying an initial drag scale factor, which is an arbitrary constant, to orbit information at the first time point; estimating an optimum drag scale factor while changing the drag scale factor until error becomes smaller than an arbitrary convergence value by comparing the predicted average semi-major axis or the argument of latitude with a preset average semi-major axis or a preset argument of latitude at the second time point; and predicting time and place of re-entry of the artificial space object into the atmosphere by performing orbit prediction with the Cowell's high-precision orbital propagator using numerical integration from the second time point to a re-entry time point and being applied with the estimated drag scale factor.

The two-line elements (TLE) may be converted into the osculating elements and an average orbit may be calculated in a true-of-date (TOD) coordinate system.

The convergence value may be a position error arbitrarily determined by a user.

As described above, according to the disclosure, the atmospheric re-entry time and place of an uncontrolled artificial space object can be precisely predicted by using the DSFE method.

### BRIEF DESCRIPTION OF THE DRAWINGS

The above and other objects, features and other advantages of the disclosure will be more clearly understood from the following detailed description when taken in conjunction with the accompanying drawings, in which:

FIG. 1 is a block diagram illustrating a system for re-entry prediction of an uncontrolled artificial space object according to an embodiment of the disclosure;

FIG. 2 is a flowchart illustrating a method for re-entry prediction of an uncontrolled artificial space object according to a first embodiment of the disclosure;

FIG. 3 is a flowchart illustrating a method for re-entry prediction of an uncontrolled artificial space object according to a second embodiment of the disclosure; and

FIG. 4 is a flowchart illustrating a method for re-entry prediction of an uncontrolled artificial space object according to a third embodiment of the disclosure.

### DETAILED DESCRIPTION

Hereinafter, exemplary embodiments of the disclosure will be described in detail with reference to the accompanying drawings, which will be readily apparent to those skilled in the art to which the disclosure pertains for the convenience of the person skilled in the art to which the disclosure pertains. The disclosure may, however, be embodied in many different forms and should not be construed as limited to the embodiments set forth herein.

Hereinafter, a system and method for re-entry prediction of an uncontrolled artificial space object according to embodiments of the disclosure will be described.

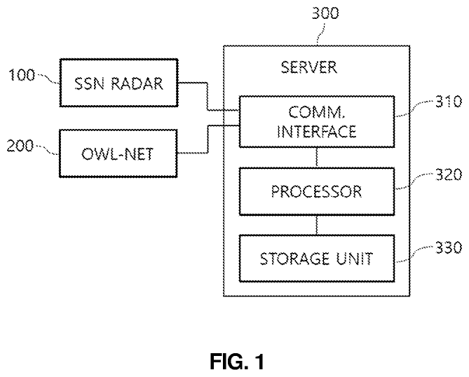

FIG. 1 is a block diagram illustrating a system for re-entry prediction of an uncontrolled artificial space object according to an embodiment of the disclosure.

Referring to FIG. 1, a system for re-entry prediction of an uncontrolled artificial space object may include a space surveillance network (SSN) radar 100 which detects, tracks, catalogs and identifies artificial space objects orbiting Earth, e.g. active/inactive satellites, spent rocket bodies, or fragmentation debris; an optical wide-field patrol network (OWL-Net) 200 which gets orbital information using purely optical means; and a server 300.

The SSN radar 100 and the OWL-Net 200 may obtain orbit information by observing the re-entry artificial space object. Here, the orbit information of the re-entry artificial space object may be two-line elements (TLE) observed by the SSN radar 100, or osculating elements observed by the OWL-Net 200.

The server 300 may include a communication interface 310 to communicate with the SSN radar 100 and the OWL-Net 200 for receiving the orbit information of a re-entry artificial space object, wherein the communication interface 310 may be a software or hardware interface; the processor 320 for predicting re-entry of the artificial space object by using the orbit information received through the communication interface 310, wherein the processor 320 may be a hardware processor and/or software processor; and the storage unit 330 for storing various information, data, programs, etc. related to the operation of the artificial space object re-entry prediction system, wherein the storage unit 330 is a non-transitory storage medium.

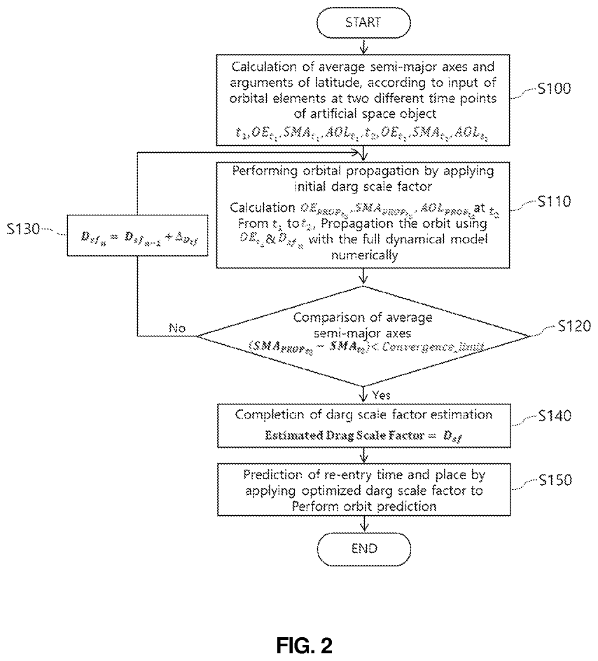

FIGS. 2 to 4 are flowcharts illustrating a method for re-entry prediction of an uncontrolled artificial space object according to first to third embodiments of the disclosure, respectively.

Referring to FIGS. 2 to 4, in the method for re-entry prediction of an uncontrolled artificial space object according to the disclosure, first, at step S100, S200, or S300, the average semi-major axes SMAₜ_{₁} and SMAₜ_{₂} and the arguments of latitude AOLₜ_{₁} and AOLₜ_{₂} of the artificial space object are calculated by inputting initial orbital elements OEₜ_{₁} and OEₜ_{₂} at two different time points t₁ and t₂.

Here, the initial orbital elements may be osculating elements observed by OWL-Net 200, or two-line elements (TLE) observed by SSN radar 100. Where the orbital elements are the two-line elements, the two-line elements are converted into osculating elements and the osculating elements may be used to calculate an average orbit in a True of Date (TOD) coordinate system. The average semi-major axes and the arguments of latitude are calculated by the processor 320 in the server 300.

Next, at step S110, S210, or S310, orbit propagation is performed up to the second time point t₂ by applying an initial Drag Scale factor D_{sf}_{₀}, which is an arbitrary constant, to the orbit information of the first time point t₁. At this time, the orbit propagation calculates the average semi-major axis

$$S M {A}_{P R O {P}_{{t}_{2}}} ,$$

argument of latitude

$$A O {L}_{P R O {P}_{{t}_{2}}} ,$$

and atmospheric drag

$${\ddot{\vec{r}}}_{D} = - \frac{1}{2} \frac{{C}_{d} A}{m} ρ {v}_{a} {\vec{v}}_{a} {D}_{s f}$$

according to the orbital element

$$0 {E}_{P R O {P}_{{t}_{2}}}$$

at the second time point t₂ predicted by a Cowell's high-precision orbital propagator using numerical integration, wherein C_{d} is a drag coefficient, A is a cross-sectional area, m is the mass, p is a degree of tightness, \vec{v}ₐ is a velocity vector, and vₐ is a velocity vector size.

The Cowell's high-precision orbital propagator is an algorithm to obtain the position and velocity of an artificial space object at an arbitrary time based on the consideration of all perturbing forces such as earth's gravitational field, atmospheric influence, attraction of sun and moon, solar radiation pressure, etc. that affect artificial space objects. Since this technique is widely known in the field, detailed description will be omitted.

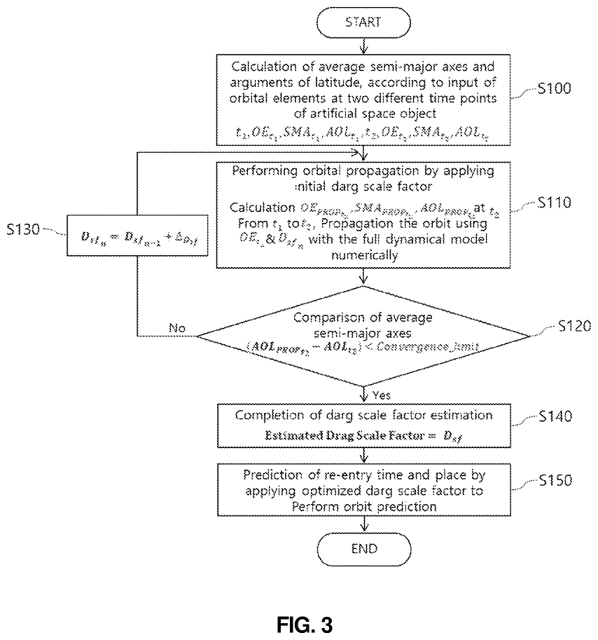

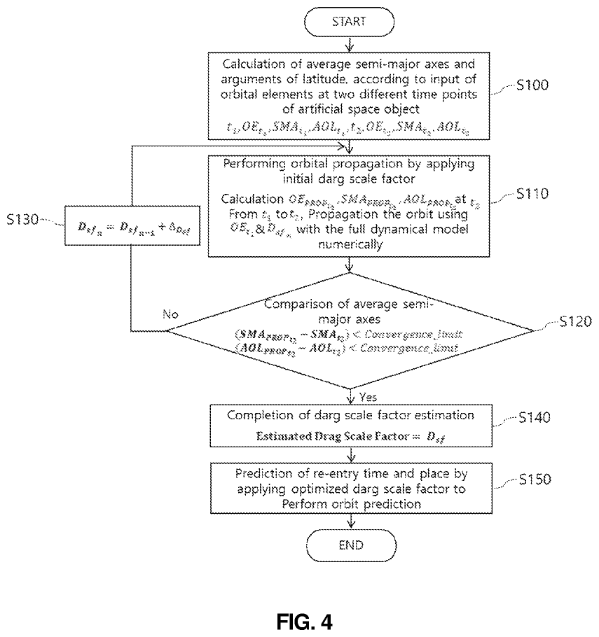

Next, when the error of a comparative value of average semi-major axes of FIG. 2, the error of a comparative value of arguments of latitude of FIG. 3, or the error of any one of the comparative value of average semi-major axis and the comparative value of arguments of latitude of FIG. 4 is compared with a convergence value at step S120, S220, or S320, and when the error reaches a minimum, the optimal drag scale factor is determined at step S140, S240, or S340. If not, the procedure is repeated while changing the drag scale factor at step S130, S230, or S330. In other words, by comparing the average semi-major axis

$$S M {A}_{P R O {P}_{{t}_{2}}}$$

or argument of latitude value

$$A O {L}_{P R O {P}_{{t}_{2}}}$$

estimated by reflecting the drag scale factor D_{sf} from the first time point t₁ to the second time point t₂ with the initially input average semi-major axis SMAₜ² or initially input argument of latitude value AOLₜ_{₂} at the second time point t₂, the optimum drag scale factor D_{sf} is found while changing the drag scale factor until the error becomes smaller than the convergence value. Here, the convergence value is a position error, for example, 10⁻⁴ km and so on, which is set arbitrarily by a user.

Next, orbit prediction is performed by applying an optimized drag scale factor D_{sf}, through the Cowell's high-precision orbital propagator using numerical integration from the second time point t₂ to a re-entry time point. Thus, the accuracy of prediction of re-entry time and place within 100 km altitude is improved, and atmospheric re-entry time and place (latitude, longitude, and altitude) of an uncontrolled artificial space object are predicted at step S150, S250, or S350.

While the disclosure has been particularly shown and described with reference to exemplary embodiments thereof, the scope of rights of the disclosure is not limited thereto and various modifications and improvements of those skilled in the art using the basic concept of the disclosure defined in the following claims are also within the scope of the disclosure.

1. A method for predicting re-entry of an uncontrolled artificial space object using a re-entry prediction system, the re-entry prediction system including a space surveillance network (SSN) radar, an optical wide-field patrol network (OWL-Net), and a server, wherein the server includes a communication interface and a processor, the method comprising:
receiving, by the server, osculating elements of the artificial space object at two different time points from the OWL-Net or two-line elements (TLE) of the artificial space object at two different time points from the SSN radar, through the communication interface;
obtaining, by the processor, a first average semi-major axis and a first argument of latitude of the artificial space object using the osculating elements or the two-line elements (TLE);
obtaining, by the processor, a second average semi-major axis, a second argument of latitude, and an atmospheric drag at a second time point of the two different time points by performing orbital propagation with a Cowell's high-precision orbital propagator using numerical integration up to the second time point, the orbital propagation being performed by applying an initial drag scale factor, which is an arbitrary constant, to orbit information at a first time point of the two different time points;
obtaining, by the processor, an optimum drag scale factor while changing the initial drag scale factor until error becomes smaller than an arbitrary convergence value, wherein the error is a difference between the first average semi-major axis or the first argument of latitude and the second average semi-major axis or the second argument of latitude at the second time point; and
obtaining, by the processor, the orbit information at a third time point by applying the optimum drag scale factor and the Cowell's high-precision orbital propagator using numerical integration from the second time point to the third time point, thereby predicting time and place of the re-entry of the artificial space object into the atmosphere.

2. The method according to claim 1, wherein the two-line elements (TLE) are converted into the osculating elements, and an average orbit is calculated based on a true-of-date (TOD) coordinate system.

3. The method according to claim 1, wherein the arbitrary convergence value is a position error arbitrarily determined by a user.

4. A system for predicting re-entry of an uncontrolled artificial space object, the system comprising:
a space surveillance network (SSN) radar configured to obtain two-line elements (TLE) of the artificial space object;
an optical wide-field patrol network (OWL-Net) configured to obtain osculating elements of the artificial space object; and
a server including:
a communication interface configured to communicate with the SSN radar and the OWL-Net for receiving orbit information of the artificial space object;
a processor configured to process the orbit information received through the communication interface; and
a storage unit configured to store data and programs,
wherein the server is configured to:
receive osculating elements of the artificial space object at two different time points from the OWL-Net or two-line elements (TLE) of the artificial space object at two different time points from the SSN radar, through the communication interface; and
wherein the processor is configured to:
obtain a first average semi-major axis and a first argument of latitude of the artificial space object using the osculating elements or the two-line elements (TLE);
obtain a second average semi-major axis, a second argument of latitude, and an atmospheric drag at a second time point of the two different time points by performing orbital propagation with a Cowell's high-precision orbital propagator using numerical integration up to the second time point, the orbital propagation being performed by applying an initial drag scale factor, which is an arbitrary constant, to orbit information at a first time point of the two different time points;
obtain an optimum drag scale factor while changing the initial drag scale factor until error becomes smaller than an arbitrary convergence value, wherein the error is a difference between the first average semi-major axis and the second average semi-major axis or a difference between the first argument of latitude and the second argument of latitude; and
obtain the orbit information at a third time point by applying the optimum drag scale factor and the Cowell's high-precision orbital propagator using numerical integration from the second time point to the third time point, thereby predicting time and place of the re-entry of the artificial space object into the atmosphere.

5. The re-entry prediction system according to claim 4, wherein the processor converts the two-line elements (TLE) into the osculating elements and calculates an average orbit based on a true-of-date (TOD) coordinate system.

6. The re-entry prediction system according to claim 4, wherein the arbitrary convergence value is a position error arbitrarily determined by a user.
